(19) United States
(12) Patent Application Publication
(10) Pub. No.: US 2023/0016916 A1
(43) Pub. Date: Jan. 19, 2023

(54) SYSTEM AND METHOD FOR DETERMINING ACTIVITY PRICING

(71) Applicant: OPENDORSE, INC., LINCOLN, NE (US)

(72) Inventors: Blake Lawrence, New York, NY (US); Abbie Giffin, Lincoln, NE (US); Brant Haupt, Lincoln, NE (US)

(21) Appl. No.: 17/855,673

(22) Filed: Jun. 30, 2022

Related U.S. Application Data
(60) Provisional application No. 63/216,695, filed on Jun. 30, 2021.

(51) Int. Cl. G06Q 30/02; G06Q 50/00

(52) U.S. Cl. CPC G06Q 30/0247; G06Q 30/0273; G06Q 50/01

(57) ABSTRACT

A method is disclosed. The method may include receiving real market data from a database; receiving user input data from a user device; retrieving a real-time current follower count for a user; determining at least one of an activity price per follower or an adjusted price per follower based on the retrieved real-time current follower count; generating an adjusted dataset by adjusting the filtered received real market data based on the determined at least one the price per follower or the adjusted price per follower; generating one or more match level tables by reducing the adjusted dataset based on one or more predetermined thresholds; generating a final dataset based on the generated one or more match level tables; and determining a suggested activity price for the user based on the generated final dataset.

### CROSS-REFERENCE TO RELATED APPLICATIONS

The present application claims the benefit under 35 U.S.C § 119 (e) of U.S. Provisional Application Ser. No. 63/216,695, filed Jun. 30, 2021, entitled SOCIAL CHANNEL VALUATION, which is incorporated herein by reference in the entirety.

### TECHNICAL FIELD

The present disclosure relates generally to activity pricing and, more particularly, to a system and method for determining activity pricing based on real market data.

### BACKGROUND

As the name, image, and likeness (NIL) endorsement market rapidly develops, there is a need for a fair market pricing tool. One of the largest challenges in such a dynamic market is setting fair market pricing for different NIL activity types. The parties are often hesitant in many cases to participate in NIL deals due to the lack of understanding and transparency surrounding the activity pricing. To further complicate the market, the number of athletes in the United States is rapidly growing and each athlete's characteristics (e.g., gender, sport, position, institution, conference, number of followers, and the like) are unique. As such, it becomes difficult to determine fair market pricing for each activity type tailored for each individual participating in such activities. \

### SUMMARY

A system is disclosed, in accordance with one or more embodiments of the present disclosure. The system includes a user interface device including a display and a user input device, the user device configured to receive user input data from a user via the user input device, the user input data including at least activity type data, user identifier data, and user channel identifier data. The system includes a platform server including one or more processors configured to execute a set of program instructions stored in a memory, the platform server including a valuation model stored in the memory, the platform server communicatively coupled to the user interface device via a network, the set of program instructions configured to cause the one or more processors to: receive real market data from a database, the real market data including completed deal data and disclosure data; receive the user input data from the user device; retrieve a real-time current follower count for the user using the received user channel identifier data; filter, using the valuation model, the received real market data based on the received user input data; determine, via the valuation model, at least one of an activity price per follower or an adjusted price per follower based on the retrieved real-time current follower count; generate an adjusted dataset, using the valuation model, by adjusting the filtered received real market data based on the determined at least one the price per follower or the adjusted price per follower; generate one or more match level tables, using the valuation model, by reducing the adjusted dataset based on one or more predetermined thresholds; generate a final dataset based on the generated one or more match level tables using the valuation model; and determine a suggested activity price for the user, using the valuation model, based on the generated final dataset.

### BRIEF DESCRIPTION OF THE DRAWINGS

The numerous advantages of the disclosure may be better understood by those skilled in the art by reference to the accompanying figures in which:

FIG. 1 illustrates a simplified block diagram of a system for determining activity pricing, in accordance with one or more embodiments of the present disclosure;

FIG. 2A illustrates a simplified block diagram depicting a method or process for determining activity pricing, in accordance with one or more embodiments of the present disclosure;

FIG. 2B illustrates a flow diagram depicting a method or process for determining activity pricing, in accordance with one or more embodiments of the present disclosure;

FIG. 3 illustrates a graphical user interface of the system for determining activity pricing, in in accordance with one or more embodiments of the present disclosure;

FIG. 4 illustrates a graphical user interface of the system for determining activity pricing, in in accordance with one or more embodiments of the present disclosure;

FIG. 5 illustrates a flow diagram depicting a method or process for determining a social post value, in accordance with one or more embodiments of the present disclosure; and

FIG. 6 illustrates a flow diagram depicting a method or process for determining an earning potential, in accordance with one or more embodiments of the present disclosure.

### DETAILED DESCRIPTION OF THE INVENTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

As the name, image, and likeness (NIL) endorsement market rapidly develops, there is a need for a fair market pricing tool. One of the largest challenges in such a dynamic market is setting fair market pricing for different NIL activity types (e.g., Facebook post, Facebook Live, Instagram Post, Twitter Post, and the like). For example, a brand may wish to enter into a deal with an individual (e.g., an athlete, coach, or the like) and leverage the individual's social media presence to gain popularity. When negotiating a sponsorship between the brand marketer and the individual, it may be desirable to determine a fair market price for the activity. Further, both parties (e.g., buyers and athletes) are often hesitant in many cases to participate in NIL deals due to the lack of understanding and transparency surrounding the activity pricing. To further complicate the market, the number of athletes (e.g., student athletes, professional athletes, retired athletes, and the like) in the United States is rapidly growing and each athlete's characteristics (e.g., gender, sport, position, institution, conference, number of followers, and the like) are unique. As such, it becomes difficult to determine fair market pricing for each individual and each activity type.

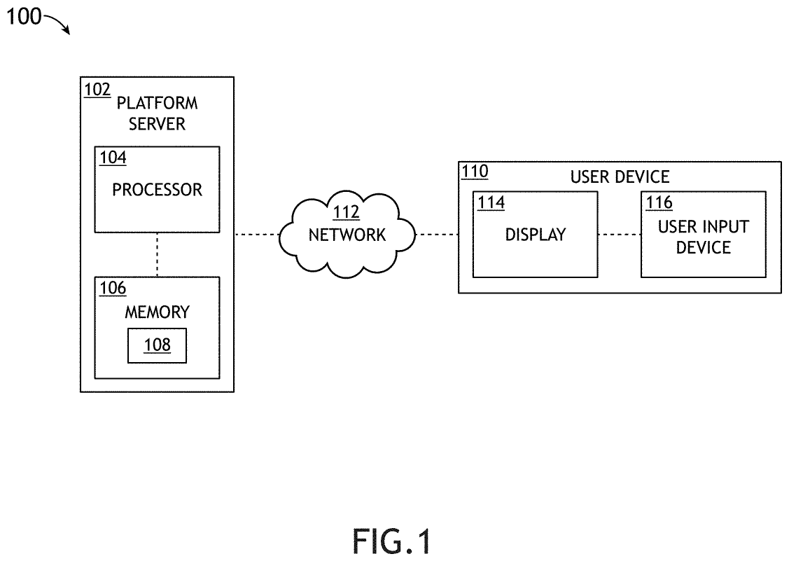

Referring generally to FIGS. 1-6, a system and method for determining activity pricing is described, in accordance with one or more embodiments of the present disclosure.

Embodiments of the present disclosure are directed to system and method for determining activity pricing. For example, the system may be configured to determine activity pricing for a user (e.g., student athlete, professional athlete, coach, or the like) based on real market data. The real market data may be a combination of completed deals (e.g., deals completed using the platform server and stored in the platform database) as well as disclosed deals (e.g., deals that were performed by individuals off platform).

The system uses real market data such as, but not limited to, completed deals, disclosures, and the like to calculate a suggested activity pricing, using a valuation model (or algorithm), based upon some or all user attributes (e.g., gender, sport, position, institution, conference, number of followers, and the like). In some embodiments, the system is configured to estimate activity pricing via the valuation model (or algorithm) for a specified user based on information received from the specified user to yield an estimated activity pricing for that specified user.

By estimating an activity price, the system can help a user determine whether a sponsorship deal is a good deal, and can, in some cases, use it as a basis for negotiating a better deal for that user.

FIG. 1 illustrates simplified block diagrams of a system 100 for determining activity pricing, in accordance with one or more embodiments of the present disclosure.

In embodiments, the system 100 includes one or more platform servers 102. The one or more platform servers 102 may include one or more processors 104 configured to execute program instructions maintained on a memory medium 106. In this regard, the one or more processors 104 of the one or more platform servers 102 may execute any of the various process steps described throughout the present disclosure. For example, the one or more processors 104 may be configured to determine activity pricing for a user (e.g., student athlete, professional athlete, coach, or the like) based on a valuation model 108 stored in memory 106. The valuation model 108 may use real market data corresponding to that individual's unique characteristics (e.g., gender, sport, position, institution, conference, number of follower, and the like) to calculate a suggested activity pricing. In this regard, the activity pricing may be beneficial in evaluating whether a sponsorship deal is appropriate. Further, the one or more platform servers 102 may be configured to receive data including, but not limited to, real market data, user data, and the like.

In embodiments, the one or more platform servers 102 may be communicatively coupled to one or more user devices 110 via the network 112. For example, the one or more platform servers 102 and/or the one or more user devices 110 may include a network interface device and/or the communication circuitry suitable for interfacing with the network 112.

The server 102 may receive information from other systems or sub-systems (e.g., a user device 110, one or more additional servers, and/or components of the one or more additional servers) communicatively coupled to the platform server 102 by a transmission medium that may include wireline and/or wireless portions. The server 102 may additionally transmit data or information to one or more systems or sub-systems communicatively coupled to the platform server 102 by a transmission medium that may include wireline and/or wireless portions. In this regard, the transmission medium may serve as a data link between the server 102 and the other systems or sub-systems (e.g., a user device 110, one or more additional servers, and/or components of the one or more additional servers) communicatively coupled to the server 102. Additionally, the server 102 may be configured to send data to external systems via a transmission medium (e.g., network connection).

The communication circuitry of the user device 110 may include any network interface circuitry or network interface device suitable for interfacing with network 104. For example, the communication circuitry 112 may include wireline-based interface devices (e.g., DSL-based interconnection, cable-based interconnection, T9-based interconnection, and the like). In another embodiment, the communication circuitry 112 may include a wireless-based interface device employing GSM, GPRS, CDMA, EV-DO, EDGE, WiMAX, 3G, 4G, 4G LTE, 5G, Wi-Fi protocols, RF, LoRa, and the like.

In embodiment, the one or more user devices 110 may be configured to receive one or more user inputs from a user. For example, the one or more user devices 110 may include a user interface, wherein the user interface includes a display 114 and a user input device 116. The one or more processors 104 may be configured to generate the graphical user interface of the display 114, wherein the graphical user interface includes the one or more display pages configured to transmit and receive data to and from a user.

The display 114 may be configured to display various selectable buttons, selectable elements, text boxes, and the like, in order to carry out the various steps of the present disclosure. In this regard, the user device 110 may include any user device known in the art for displaying data to a user including, but not limited to, mobile computing devices (e.g., smart phones, tablets, smart watches, and the like), laptop computing devices, desktop computing devices, and the like. By way of another example, the user device 110 may include one or more touchscreen-enabled devices. In embodiments, the display 114 includes a graphical user interface, wherein the graphical user interface includes one or more display pages configured to display and receive data/information to and from a user. The display 114 may include any display device known in the art. For example, the display 114 may include, but is not limited to, a liquid crystal display (LCD), an organic light-emitting diode (OLED) based display, a CRT display, and the like.

The user input device 116 may be coupled with the display 114 by a transmission medium that may include wireline and/or wireless portions. The user input device 116 may include any user input device known in the art. For example, the user input device 116 may include, but is not limited to, a keyboard, a keypad, a touchscreen, a lever, a knob, a scroll wheel, a track ball, a switch, a dial, a sliding bar, a scroll bar, a slide, a handle, a touch pad, a bezel input device or the like. In the case of a touchscreen interface, several touchscreen interfaces may be suitable. For instance, the display 114 may be integrated with a touchscreen interface, such as, but not limited to, a capacitive touchscreen, a resistive touchscreen, a surface acoustic based touchscreen, an infrared based touchscreen, or the like.

The communication circuitry of the server 102 may include any network interface circuitry or network interface device suitable for interfacing with network 104. For example, the communication circuitry 118 may include wireline-based interface devices (e.g., DSL-based interconnection, cable-based interconnection, T9-based interconnection, and the like). In another embodiment, the communication circuitry 112 may include a wireless-based interface device employing GSM, GPRS, CDMA, EV-DO, EDGE, WiMAX, 3G, 4G, 4G LTE, 5G, Wi-Fi protocols, RF, LoRa, and the like.

In embodiments, the one or more processors 104 may include any one or more processing elements known in the art. In this sense, the one or more processors 104 may include any microprocessor-type device configured to execute software algorithms and/or instructions. For example, the one or more processors 104 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 104. In general, the term “processor” may be broadly defined to encompass any device having one or more processing elements, which execute program instructions from memory 106. Moreover, different subsystems of the system 100 (e.g., user device 110, network 112, server 102) may include processor or logic elements suitable for carrying out at least a portion of the steps described throughout the present disclosure. Therefore, the above description should not be interpreted as a limitation on the present disclosure but merely an illustration.

The memory 106 may include any storage medium known in the art suitable for storing program instructions executable by the associated one or more processors 104. For example, the memory 106 may include a non-transitory memory medium. For instance, the memory 106 may include, but is not limited to, a read-only memory (ROM), a random-access memory (RAM), a magnetic or optical memory device (e.g., disk), a solid-state drive, and the like. It is further noted that memory 106 may be housed in a common controller housing with the one or more processors 104. In an alternative embodiment, the memory 106 may be located remotely with respect to the physical location of the processors 104, user device 110, server 102, and the like. For instance, the one or more processors 104 and/or the server 102 may access a remote memory (e.g., server), accessible through a network (e.g., internet, intranet and the like). The memory 106 may also maintain program instructions for causing the one or more processors 104 to carry out the various steps described through the present disclosure.

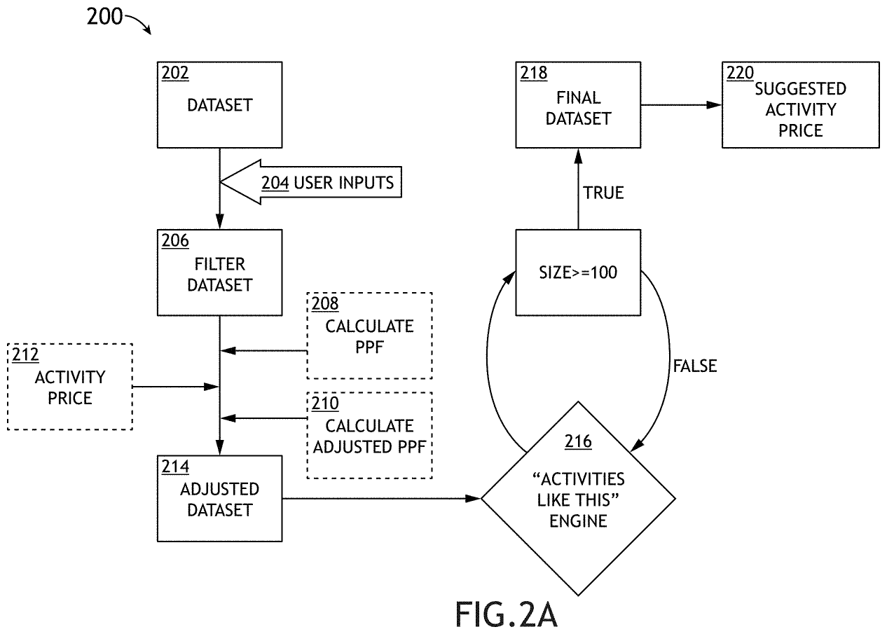

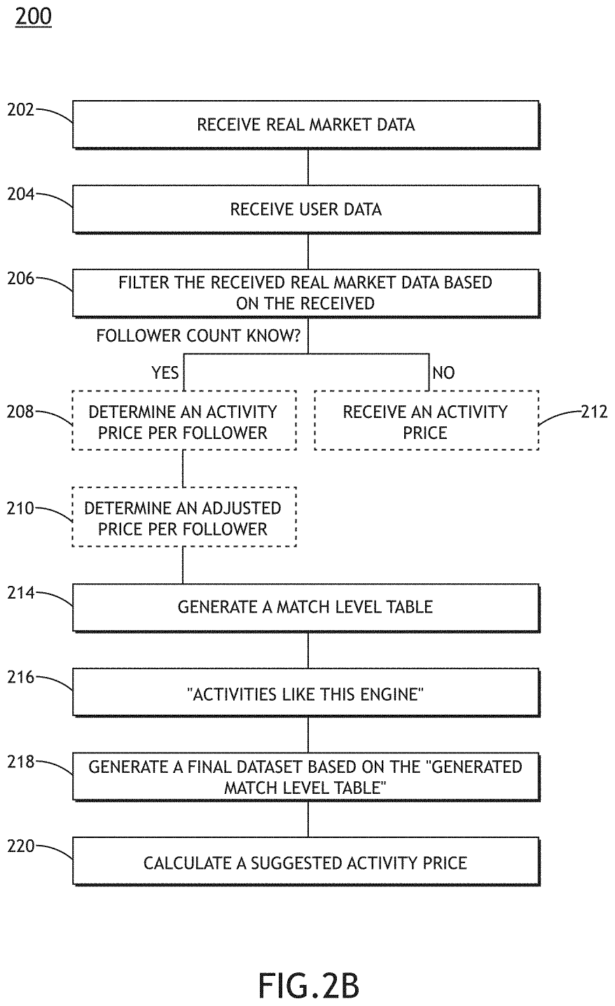

The various steps and functions carried out by the one or more processors 104 may be further understood with reference to FIGS. 2A-6. Furthermore, any functions and/or steps shown and described as being carried out by processors of the user devices 110 may additionally and/or alternatively be carried out by the one or more processors 104 of the server 102.

FIG. 2A-2B illustrate flow diagrams depicting a method or process 200 performed by the system 100 to determine activity pricing, in accordance with one or more embodiments of the present disclosure. The system 100 may perform these steps for a specified activity for a specified user. These steps may be performed periodically for each activity/user, such as daily, weekly, monthly, or the like.

In step 202, the system 100 may receive real market data. For example, the one or more processors 104 of the platform server 102 may be configured to receive real market data from a database 118 (stored in memory 106 or a remote database) to train the valuation model 108 stored in memory 106. The database 118 may include real market data such as, but is not limited to, completed deals (e.g., deals completed using the platform server and stored in the platform database), disclosures (e.g., disclosed deals performed by individuals off the platform), or the like.

TABLE 1

| ID | ACCOUNTID | ACTIVITYTYPEID | MARKETPRICE |
|---|---|---|---|
| 10001 | 3542 | 1024 | 621 |
| 10002 | 3542 | 512 | 234 |
| 10003 | 3542 | 16 | 250 |
| 10005 | 3542 | 2048 | 145 |
| 10006 | 3542 | 1 | 2,130 |
| 10007 | 3542 | 33554432 | 650 |
| 10008 | 3391 | 1 | 133 |
| 10009 | 3391 | 1024 | 523 |
| 10010 | 3391 | 512 | 154 |
| 10011 | 3391 | 16 | 721 |
| 10012 | 3391 | 33554432 | 451 |
| 10013 | 3391 | 2048 | 565 |

Referring to Table 1, the database 118 may include a dataset including at least one of a unique identifier (ID), an account ID, an activity type ID, a market price (in dollars), and the like. For example, the dataset may include unique ID for an activity price for a specific individual's account. By way of another example, the dataset may include an account ID tied to a registered user's account/record. By way of another example, the dataset may include a suggested market price (determined in step 220). It is noted that Table 1 is provided merely for illustrative purposes and shall be construed as limiting the scope of the present disclosure.

In step 204, the system 100 may receive user data. For example, the one or more processors 104 of the platform server 102 may be configured to receive user data from the user device 110. The user data may include, but is not limited to, activity type (e.g., Twitter post, Twitter fleet, Facebook post, Facebook story, Facebook live, TikTok, Instagram Post, Instagram story, Instagram IGTV, Instagram reel, Youtube, Photo/video/audio creation, Podcast appearance, digital press interview, appearance/meet-and-greet, autograph signing, in-person interview, keynote speech, production shoot, sport demonstration, and the like), identifier (e.g., student athlete, professional athlete, retired athlete, agent, coach, and the like), sport type (e.g., football, women's basketball, men's basketball, and the like), institution (e.g., school name, team name, and the like), conference (e.g., Big 12, Big 10, and the like), league/division, social media handle/profile link to determine a current follower count (e.g., for a specified platform or across all known platforms), and the like.

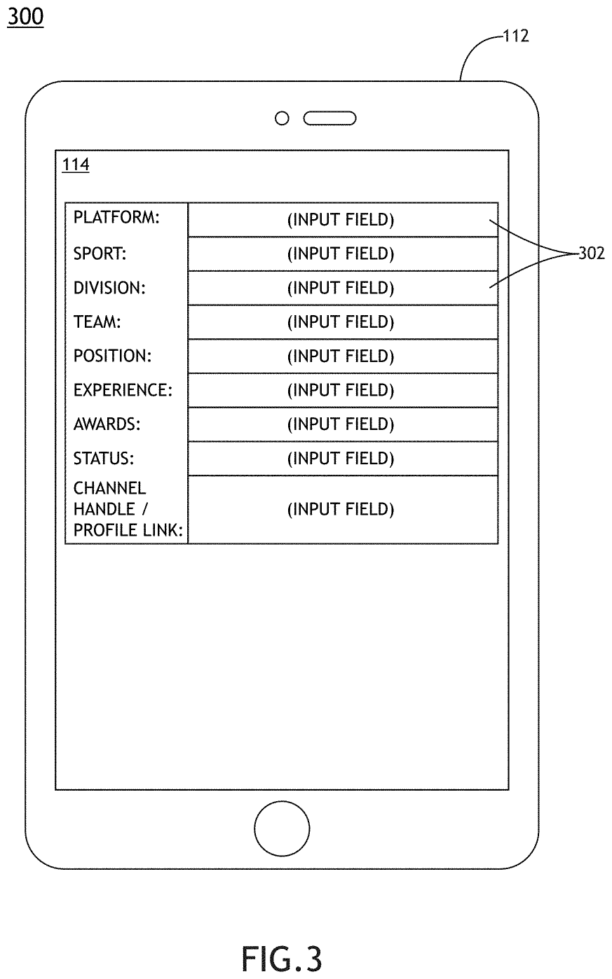

FIG. 3 illustrates a graphical user interface (GUI) 300 of the system 100, in accordance with one or more embodiments of the present disclosure. The GUI 300 may be displayed on a display device 114 (e.g., of the user device 110).

The GUI 300 may include one or more fields 302 (e.g., manually-entered fields, drop-down menu fields, or the like) in which information or data may be entered. For example, the one or more fields may include, but are not limited to, a platform field, a sport field, a division field, a team field, a position field, an experience field, an awards field, a status field, and a social media handle/profile link field. Although FIG. 3 depicts various data input fields, it is noted that FIG. 3 is provided merely for illustrative purposes and shall not be construed as a limitation on the scope of the present disclosure. In this regard, such data may be determined by a communication between the server 102 and a social media platform (e.g., by an Application Programming Interface (API) request).

In step 206, the system 100 may filter the received real market data based on the received user data. In one non-limiting example, the one or more processors 104 of the platform server 102 may be configured to filter the received real market data, via the valuation model 108, based at least one of a selected identifier (e.g., which sport an individual participates in) or a selected activity type received from the user (in step 204). In this example, the one or more processors 104 of the platform server 102 may be configured to filter the received real market data based on the student athlete identifier and social post activity type. In this regard, the calculated activity pricing (calculated in step 220) may provide an accurate estimate of a user's market value for a specific social post activity type based on relevant real market data corresponding to the student athlete market. For example, in a non-limiting example, if a Division I quarterback does an Instagram post for $2,000, then the valuation model 108 may be configured to determine what an accurate suggested activity price should be for a similar individual and similar activity type based on the received real market data.

In an optional step 208, if social media follower count is known, the system 100 may determine an activity price per follower (PPF). For example, the one or more processors 104 of the platform server 102 may be configured to determine an activity PPF, using the valuation model 108, based on Equation 1 (Eqn. 1), which is shown and described below:

$$P P F = \frac{Activity Price}{Follower Count} \qquad Eqn . 1$$

In Eqn. 1, the activity price may be the suggested activity price (calculated in step 220). The one or more processors 104 of the platform server 102 may be configured to determine a real-time follower count based the user's inputted social media handle or profile link. For example, the user may input their social media handle or profile link such that the one or more processors 104 of the platform server 102 may be able to retrieve the user's real-time follower count.

In an optional step 210, if social media follower count is known, the system 100 may determine an adjusted PPF. For example, the one or more processors 104 of the platform server 102 may be configured to determine an adjusted PPF, using the valuation model 108, based on Equation 2 (Eqn. 2), which is shown and described below:

Adjusted PPF=PPF×Buyer Modifier Eqn. 2

The buyer modifier may include a donor modifier, sponsor modifier, brand modifier, fan modifier, a collective modifier (e.g., specific group of individuals who support a particular institution), and the like. In one non-limiting example, the modifiers may be 0.10 for a donor, 0.50 for a sponsor, 0.75 for a brand, and 1.00 for a fan. In another non-limiting example, the modifiers may be 0.10 for a donor, 0.15 for a sponsor, 0.20 for a brand, and 1.00 for a fan. In another non-limiting example, the modifiers may be 0.10 for a donor, 0.15 for a sponsor, 0.20 for a brand, 0.50 for a collective, and 1.00 for a fan. It is noted that the buyer modifier may be any predetermined modifier factor configured to weight the value.

In an optional step 212, if social media follower count is unknown, the system 100 may receive an activity price. For example, the one or more processors 104 of the platform server 102 may be configured to receive an activity price calculated in step 220.

In step 214, the system 100 may generate an adjusted dataset based on at least one of the calculated PPF (step 208), adjusted PPF (step 210), or activity price (step 212). For example, the adjusted dataset may be weighted by buyer type, such that the non-fan buyer would be discounted compared to a fan.

In step 216, the system 100 may generate a match level table based on one or more predetermined thresholds by reducing the adjusted dataset (from step 214). For example, the one or more processors 104 of the platform server 102, using the valuation model 108, may be configured to generate a match table (such as the match table shown in Table 3) by reducing the adjusted dataset (from step 214) based on one or more predetermined thresholds (as shown by Table 2). The one or more predetermined thresholds may include, but are not limited to, similar athlete, sport and institution, sport and conference, sport and league/division, institution, conference, league/division, and the like. In this regard, the match table may include the closest matching activity based on the one or more predetermined thresholds such that the activity price determined in step 220 reflects the real market data.

For example, as shown in Table 2, a match table may be generated based one or more predetermined thresholds associated with one or more match levels. In one instance, a first portion of the match table may be generated for a match level 1 including data that matches the “exact athlete”, where there may be 25 datapoints (or duplications). In another instance, a second portion of the match table may be generated for a match level 2 including data that matches the “sport+institution”, where there may be 15 datapoints (or duplications). In another instance, a third portion of the match table may be generated for a match level 3 including data that matches the “sport+conference”, where there may be 10 datapoints (or duplications). In another instance, a fourth portion of the match table may be generated for a match level 4 including data that matches the “sport+league/division”, where there may be 5 datapoints (or duplications). In another instance, a fifth portion of the match table may be generated for a match level 5 including data that matches the “institution”, where there may be 3 datapoints (or duplications). In another instance, a sixth portion of the match table may be generated for a match level 6 including data that matches the “conference”, where there may be 2 datapoints (or duplications). In another instance, a seventh portion of the match table may be generated for a match level 7 including data that matches the “league/division”, where there may be 1 datapoint (or duplications).

TABLE 2

| Match Level | Matching Fields | Duplications |
|---|---|---|
| 1 | Exact Athlete | 25 |
| 2 | Sport + Institution | 15 |
| 3 | Sport + Conference | 10 |
| 4 | Sport + League/Division | 5 |
| 5 | Institution | 3 |
| 6 | Conference | 2 |
| 7 | League/Division | 1 |

In a non-limiting example, the user may be Charles Johnson, a football player at Lincoln University. The system may be configured to generate a match table including Match Level 2 data (as shown in Table 3) that matches level “sport+institution/team” (as identified in Table 2 above). As shown, the match table (Table 3) may include the parties to the deal (e.g., sender and recipient), sport type, institution/team, deal date, activity ID and type, price, buyer modifier type, and match level (e.g., Level 2).

TABLE 3

| SENDER | SENDER | RECIPIENT | | | | | |
|---|---|---|---|---|---|---|---|
| ACCOUNT | ACCOUNT | ACCOUNT | | | | | DEAL CREATE |
| NAME | IDENTIFIER | ID | RECIPIENTACCOUNTNA | | SPORT | TEAM | DATE |
| GummiShot | Advertiser | 469268 | Tyler | Duerbeck | Football | Lincoln | Mar. 31, 2022 |
| | | | | | | University | |
| GummiShot | Advertiser | 469268 | Tyler | Duerbeck | Football | Lincoln | Mar. 31, 2022 |
| | | | | | | University | |
| Gopuff | Advertiser | 469280 | Dontonio | Moore | Football | Lincoln | Jan. 27, 2022 |
| | | | | | | University | |
| Gopuff | Advertiser | 469357 | Christopher | Parker | Football | Lincoln | Jan. 27, 2022 |
| | | | | | | University | |
| Gopuff | Advertiser | 469239 | Timothy | Sisson | Football | Lincoln | Jan. 27, 2022 |
| | | | | | | University | |
| Gopuff | Advertiser | 469325 | Devyn | Sigars | Football | Lincoln | Jan. 27, 2022 |
| | | | | | | University | |
| Gopuff | Advertiser | 469302 | Jahkari | Larmond | Football | Lincoln | Jan. 19, 2022 |
| | | | | | | University | |
| Gopuff | Advertiser | 469302 | Jahkari | Larmond | Football | Lincoln | Jan. 19, 2022 |
| | | | | | | University | |
| Gopuff | Advertiser | 469268 | Tyler | Duerbeck | Football | Lincoln | Jan. 19, 2022 |
| | | | | | | University | |
| Gopuff | Advertiser | 469268 | Tyler | Duerbeck | Football | Lincoln | Jan. 19, 2022 |
| | | | | | | University | |
| Gopuff | Advertiser | 469336 | LaMarr | Spencer | Football | Lincoln | Jan. 28, 2022 |
| | | | | | | University | |
| Gopuff | Advertiser | 469247 | Caleb | Freeland | Football | Lincoln | Jan. 28, 2022 |
| | | | | | | University | |
| Gopuff | Advertiser | 469258 | Cameron | Hawkins | Football | Lincoln | Jan. 28, 2022 |
| | | | | | | University | |
| Gopuff | Advertiser | 469344 | Tyler | Geide | Football | Lincoln | Jan. 28, 2022 |
| | | | | | | University | |
| Gopuff | Advertiser | 469312 | Jharod | Johnson | Football | Lincoln | Jan. 28, 2022 |
| | | | | | | University | |
| Gopuff | Advertiser | 469278 | Aderias | Ealy | Football | Lincoln | Jan. 28, 2022 |
| | | | | | | University | |
| Gopuff | Advertiser | 469238 | Thomas | Medellin | Football | Lincoln | Jan. 28, 2022 |
| | | | | | | University | |

| SENDER | | | | | | |
|---|---|---|---|---|---|---|
| ACCOUNT | ACTIVITY | ACTIVITY | PARENT | ADJ | | MATCH |
| NAME | ID | TYPE | ACTIVITY | PRICE | SEGMENT | LEVEL |
| GummiShot | 63437 | 262144 | VIDEO | $5.00 | BRAND | 2 |
| | | | SHOUTOUT | | | |
| GummiShot | 63434 | 262144 | VIDEO | $5.00 | BRAND | 2 |
| | | | SHOUTOUT | | | |
| Gopuff | 52623 | 262144 | VIDEO | $6.00 | BRAND | 2 |
| | | | SHOUTOUT | | | |
| Gopuff | 50096 | 262144 | VIDEO | $6.00 | BRAND | 2 |
| | | | SHOUTOUT | | | |
| Gopuff | 50086 | 262144 | VIDEO | $6.00 | BRAND | 2 |
| | | | SHOUTOUT | | | |
| Gopuff | 49992 | 262144 | VIDEO | $6.00 | BRAND | 2 |
| | | | SHOUTOUT | | | |
| Gopuff | 48043 | 262144 | VIDEO | $6.00 | BRAND | 2 |
| | | | SHOUTOUT | | | |
| Gopuff | 48042 | 262144 | VIDEO | $6.00 | BRAND | 2 |
| | | | SHOUTOUT | | | |
| Gopuff | 48035 | 262144 | VIDEO | $6.00 | BRAND | 2 |
| | | | SHOUTOUT | | | |
| Gopuff | 48034 | 262144 | VIDEO | $6.00 | BRAND | 2 |
| | | | SHOUTOUT | | | |
| Gopuff | 57839 | 262144 | VIDEO | $6.00 | BRAND | 2 |
| | | | SHOUTOUT | | | |
| Gopuff | 57038 | 262144 | VIDEO | $6.00 | BRAND | 2 |
| | | | SHOUTOUT | | | |
| Gopuff | 55773 | 262144 | VIDEO | $6.00 | BRAND | 2 |
| | | | SHOUTOUT | | | |
| Gopuff | 55674 | 262144 | VIDEO | $6.00 | BRAND | 2 |
| | | | SHOUTOUT | | | |
| Gopuff | 55292 | 262144 | VIDEO | $6.00 | BRAND | 2 |
| | | | SHOUTOUT | | | |
| Gopuff | 54339 | 262144 | VIDEO | $6.00 | BRAND | 2 |
| | | | SHOUTOUT | | | |
| Gopuff | 53904 | 262144 | VIDEO | $6.00 | BRAND | 2 |
| | | | SHOUTOUT | | | |

In step 218, the system 100 may generate a final dataset. For example, the one or more processors 104 of the platform server 102, using the valuation model 108, may be configured to generate a final dataset based on the generated match table (in step 216) by duplicating the number of times the user input data matches the data in the match level table. For instance, the one or more processors 104 of the platform server 102 may be configured to generate a final dataset, where the match level table is sorted by match level (ascending) and activity date (descending). In a non-limiting example, the top 100 rows/activities of the match level table may be kept. Further, 25% of the dataset may be reserved for market influence (e.g., excluding match level 1) to prevent an athlete who has done a lot of deals from going stale if the market spikes. It is noted that the final dataset may include any amount of comparison data (e.g., rows of data) suitable for determining the suggested activity price (in step 220).

In a step 220, the system 100 may determine a suggested activity price. For example, the one or more processors 104 of the platform server 102 may be configured to determine a suggested activity price, using the valuation model 108, based on Equation 3 (Eqn. 3), which is shown and described below:

Suggested Activity Price=Mean (AdjPPF)×Follower Count Eqn. 3

For instance, the one or more processors 104 of the platform server 102 may be configured to determine the suggested activity price based on the follower count received from the user (in step 204) and the calculated adjusted PPF (in step 210), where the one or more processors 104 of the platform 102 may be configured to determine the mean value of the calculated adjusted PPF (from step 210).

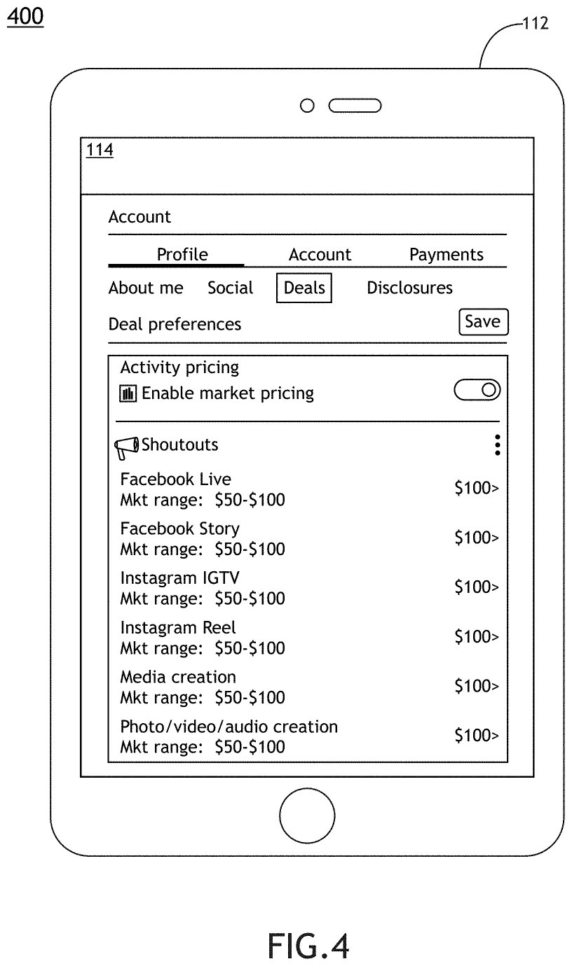

FIG. 4 illustrates a graphical user interface (GUI) 500 of the system 100, in accordance with one or more embodiments of the present disclosure. In embodiments, the user device 112 may display the calculated suggested activity price (from step 220) on display 114 via the GUI 400. For example, the GUI 400 may list a market range for each specific activity type (e.g., Facebook Live, Facebook Story, Instagram IGTV, Instagram Reel, Media Creation, Photo/video/audio creation, and the like), which is tailored for that specific user (e.g., based on the real market data and user input data).

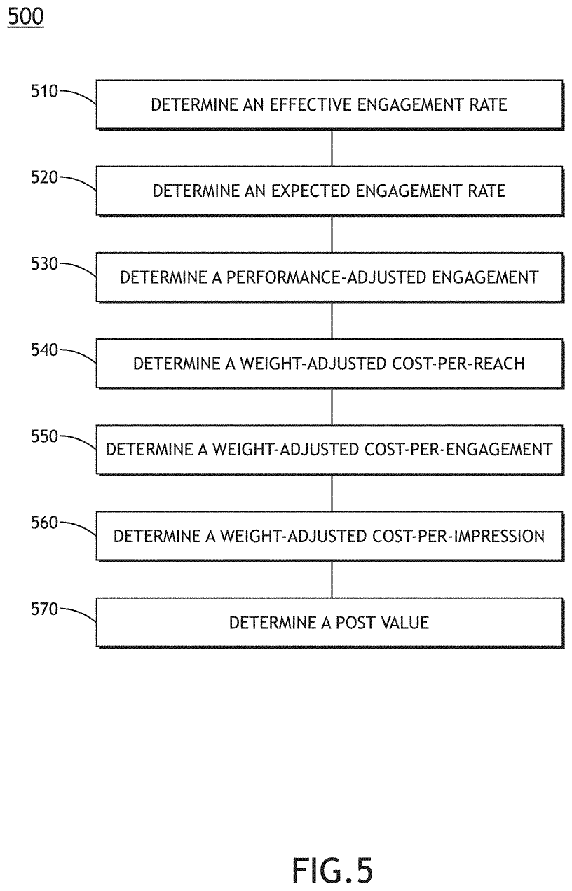

FIG. 5 depicts a flow diagram of a method or process 600 of determining a social post value, in accordance with one or more embodiments of the present disclosure.

Embodiments of the present disclosure are further directed to determining a post value for posts on a social channel. The post value may be determined based on input parameters. Some of the input parameters may be specific to the user. Others of the input parameters may be broadly determined based on historical data. Furthermore, the input parameters for determining the social channel post value may include input parameters which are general across sports and platforms, together with input parameters which are specific to a platform and/or a sport. Such input parameters may be received by way of a network (e.g., network 112). Such network may receive the input parameters from one or more user devices (e.g., user device 110) or the social media platform (e.g., by an Application Programming Interface (API) request).

In embodiments, the input parameters include a channel follower count and a status multiplier.

The channel follower count may be a number people who follow the user (e.g., subscribe). Such followers may receive notifications when a post is made on the social channel and/or may view the post directly. In this regard, the channel follower count may provide a baseline metric for people who would view a social channel post. Such followers may additionally share or publish the social channel post. Many social media platforms provide a real-time value of the channel follow count.

The status multiplier may be a value given based on an identifier of the user. For example, where the user is an athlete, the value multiplier may be given based on a status of the athlete, such as, but not limited to, a student-athlete, a professional athlete, an agent, or a coach. In embodiments, the status multiplier may have an unbounded range greater than or equal to zero.

In embodiments, the input parameters may also include one or more of a post market value, a performance score, a cost-per-reach, a cost-per-engagement, a cost-per-impression, a performance score, an impression estimate, a cost-per-metric weight, and an average engagement rate. One or more of such input parameters may be defaulted to a zero value, unless otherwise specified (e.g., by the user device 110 or server 102).

A reach may correspond to the channel follower count. A cost-per-reach (CPR) may be based on the reach. The cost-per-reach is a monetary value derived from the number of followers that a post can potentially reach together with an associated cost. The cost-per-reach may be calculated using real world data based on a posts market value and together with a follower count of the poster. For example, cost-per-reach=(post market value)/(follower count).

An engagement may be a number of times people have engaged with a sponsored post. A cost-per-engagement (CPE) may be based on the number of engagements. The cost-per-engagement is a monetary value derived from the number of engagements a sponsored post receives together with an associated cost. The cost-per-engagement may be calculated using real world data. For example, cost-per-engagement=(post market value)/(post engagements).

An impression may correspond to a number of likes, views, shares, or comments a post receives. A cost-per-impression (CPM) may be based on the number of impressions the post receives together with the post market value. The cost-per-impression may be calculated using real world data. For example, cost-per-impression=(post market value)/(post impressions).

A performance score may be an expected performance, relative to past sponsored posts from athletes in the same sport as the user. The performance score may include a range of positive and/or negative values. For example, the performance score may include a value from negative three to three, inclusive. Where the performance score has a negative value, past sponsored posts have had a worse-than-expected performance. Where the performance score has a zero value, there may be insufficient data or past sponsored posts have performed as expected. Where the performance score has a positive value, past sponsored posts from have had a better-than-expected performance.

An impression estimate may be an estimated impression for a post. The impression estimate may be represented as a percentage of the user's following. In this regard, the impression estimate may include a range from zero to one, inclusive.

A cost-per-metric weight may be a weight associated with a given metric. For example, various metrics may include, but are not limited to, cost-per-reach, cost-per-engagement, and cost-per-impression. Such metrics may each include a weight. The weight may have a range from zero to one, inclusive. In embodiments, the cost-per-metric weight is a required value, with no default provided. In this regard, the channel holder and/or a sponsor may determine which they value more (e.g., CPR, CPE, or CPM) when evaluating sponsorships and input the cost-per-metric weights accordingly.

An average engagement rate (AER) may be an expected engagement rate for a sponsored post based on the average engagement rate for athlete's in the same sport and follower count bucket as the user. The average engagement rate may be calculated using real world data. For example, such data may be determined by an Opendorse platform. The follower count bucket may include a range of followers, such as, but not limited to: 0 to 999 followers; 1,000 to 9,999 followers; 10,000 to 99,999 followers; 100,000 to 999,999 followers; 1,000,000 to 9,999,999 followers, and 10,000,000 or greater followers.

In a step 502, an effective engagement rate (EER) may be determined. Some social channels may provide a user with an engagement rate of the user's posts (e.g., via channel analytics). If the engagement rate of the channel is known, the actual engagement rate may be used as an effective engagement rate input. By using the actual engagement rate, the effective engagement rate may most accurately represent the engagement of the user's followers. However, the actual engagement rate may not be known or may otherwise be difficult to obtain for the user. If the engagement rate of the channel is not known, the average engagement rate (AER) may be used as the effective engagement rate. The average engagement rate may be based on historical average engagement rates of various social channels.

In a step 504, an expected engagements (EE) may be determined. The expected engagements may be indicative of a number of expected engagements for the user's post, based on the effective engagement rate multiplied by a number of the user's channel followers. For example, the expected engagements=(channel follower count)*the effective engagement rate.

In a step 506, a performance-adjusted engagement may be determined. The performance-adjusted engagement may be determined based on the expected engagements together with the performance score. Depending on the value of the performance score, an equation for determining the adjusted engagements may vary. For example, where the performance score is less than negative one, the performance-adjusted engagements=−(expected engagements)/(performance score). By way of another example, where the performance score is less than zero but greater than or equal to negative one, the performance-adjusted engagements=−(expected engagements)*(performance score). By way of another example, where the performance score is greater than or equal to zero, the performance-adjusted engagements=(expected engagements)*(performance score).

In embodiments, one or more adjusted cost metrics may be determined, the adjusted cost metrics may include one or more of the following: an adjusted cost-per-reach (Adjusted CPR); an adjusted cost-per-engagement (Adjusted CPE); and/or an adjusted cost-per-impression (Adjusted CPM).

In a step 508, the adjusted cost-per-reach may be determined. The adjusted cost-per-reach may be based on the follower count, the status multiplier, and the unweighted cost-per-reach. for example, the adjusted cost-per-reach=(follower count)/1000*(status multiplier)*unweight cost-per-reach.

Ina step 510, the adjusted cost-per-engagement may be determined. The adjusted cost-per-engagement may be based on the adjusted engagements, the status multiplier, and the unweighted cost-per-engagement. For example, the adjusted cost-per-engagement=(adjusted engagements)*(status multiplier)*unweighted cost-per-engagement.

In a step 512, the adjusted cost-per-impression may be determined based on the follower count, the impression estimate, the status multiplier, and the unweighted cost-per-impression. For example, adjusted cost-per-impression=(follower count)*(impressions estimate)/1000*(status multiplier)*unweighted cost-per-impression.

In embodiments, the cost metrics (e.g., CPR, CPE, and CPM) may each include a weight. The weight may be a scale by which a given Adjusted Cost metric is weighted. The weight may include a range of values, inclusive from zero to one. By multiplying the weight with the adjusted cost metric, a weight-adjusted cost metric may be determined. For example, a weight-adjusted cost-per-reach may be determined by multiplying the adjusted cost-per-reach by a weight of the cost-per-reach. By way of another example, a weight-adjusted cost-per-engagement may be determined by multiplying the adjusted cost-per-engagement by a weight of the cost-per-engagement. By way of another example, a weight-adjusted cost-per-impression may be determined by multiplying the adjusted cost-per-impression by a weight of the cost-per-impression.

In a step 512, the weight-adjusted cost metrics are used to determine a post value, such that the cost metric weights may be required for determining the post value. The post value may be determined by adding the weight-adjusted cost-per-reach, the weight-adjusted cost-per-engagement, and the weight-adjusted cost-per-impression. For example, post value=weight-adjusted CPR+weight-adjusted CPR+weight-adjusted CPM.

The post value may then be provided to the user and/or the sponsor. For example, the post value may be provided to the user device of the user by way of the network. In this regard, a recommendation of appropriate pricing for the post may be determined for the user.

Post values may also be determined for multiple channels of the user. In embodiments, a total post value may be determined. The total post value may equal to a sum of the post values for each channel of the users.

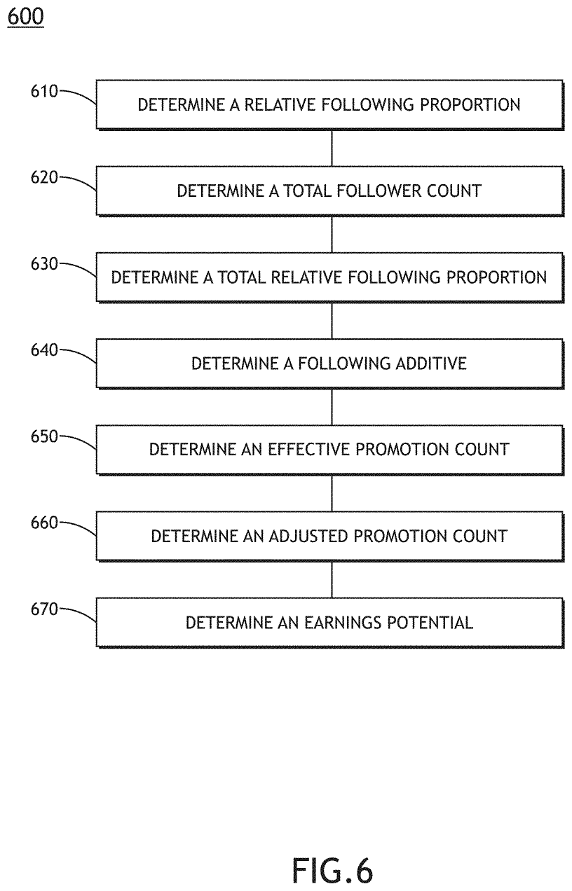

FIG. 6 illustrates a flow diagram depicting a method or process 600 of determining an earning potential, in accordance with one or more embodiments of the present disclosure.

Embodiments of the present disclosure are directed to determining an earning potential for a user. The earning potential may be determined based on one or more earning potential input parameters. For example, the input parameters may include, but are not limited to, a base promotion count, an average sport follower count for the platform, and an average sport follower count across platforms.

A base promotion count may include a number of sponsored posts a user can expect to receive based on the user's sport. For example, the base promotion count may include a range from zero to 104, inclusive.

An average sport follower count for the platform (ASFC_platform) may be an average follower count for athletes in the same sport on the platform of the channel.

A total average sport follower count (ASFC_total) may be an average follower count for athletes in the same sport summed across all platforms.

The input parameters used to determine the earning potential may include, but are not limited to, a maximum promotion count, a channel follower count, a team-sport multiplier, a team multiplier, a position multiplier, an experience multiplier, an award multiplier, a division multiplier, an alma mater, and/or a status multiplier.

A maximum promotion count may include a number of promotions a user can expect to receive in one year. For example, athletes may expect a maximum promotion count of 104 promotions per year.

A channel follower count may include a number of followers who follow the user (e.g., subscribe). Such followers may receive notifications when a post is made on the social channel and/or may view the post directly. In this regard, the channel follower count may provide a baseline metric for people who would view a social channel post. Such followers may additionally share or publish the social channel post. Many social media platforms provide a real-time value of the channel follow count.

A team-sport multiplier may be a value multiplier given based on a combination of the user's team and sport. The team-sport multiplier may be determined from an average performance of posts published by athletes in the same cohort as the user.

A team multiplier may be a value multiplier given based on the user's team. The team multiplier may be determined from average performance of posts published by athletes in the same cohort as the channel holder.

A position multiplier may be a value multiplier given based on the user's position in a sport. The position multiplier may be derived from average performance of posts published by athletes in the same cohort as the user.

An experience multiplier may be a value multiplier given based on the user's experience. The experience multiplier may be derived from average performance of posts published by athletes in the same cohort as the user. The experience multiplier may include a range from zero to one, inclusive, and may include a default value of one half. For example, the experience of the user may include a freshman, a sophomore, a junior, a senior, a graduate, a recruit, a rookie, or a veteran.

An award multiplier may be a value multiplier given based on the user's highest honor award. The award multiplier may be derived from average performance of posts published by athletes with similar player awards. For example, the various performance awards a user may receive, include, but are not limited to, a Heisman, a Collegiate All-Conference, or an Academic All-American.

A division multiplier may be a value multiplier given based on the user's division in a relevant sport. The division multiplier may be derived from average performance of posts published by athletes in the same cohort. For example, the user may be a college athlete, and the division multiplier may be spilt into various college divisions, such as, but not limited to, Division I, II, or III. By way of another example, the user may be a post-college baseball player and the division multiplier may be split into various professional baseball divisions, such as the Major Leagues, a AAA league, a AA league, an A league, or a rookie league.

A status multiplier may be a value multiplier based on the user's status. The status multiplier may be derived from average performance of posts published by athletes in the same cohort. For example, the status of the user may include, but is not limited to, a student-athlete, a professional athlete, a retired athlete, or a coach.

The athlete earning potential may then be determined based on the one or more input parameters, as described further herein.

In a step 602, a relative following proportion may be determined for each channel of the user. The relative following proportion may be determined based on a follower count of the user, together with an average sport follower count for the platform. If the user has multiple channels on the same platform, a maximum of the Relative Following Proportion between the multiple channels of the platform may be taken. For example, relative following proportion=(follower count)/the average sport follower count associated with the platform. The relative following proportion may include any suitable range based on the follower count and the average sport follower count associated with the platform, such as, but not limited to, zero or a number greater than zero.

In a step 604, a total relative follower proportion may be determined. A total follower count may be equal to a sum of the follower count of each platform on which the user has a channel. The total relative follower proportion may be equal to the total follower count divided by the total average sports follower count. For example, total relative follower proportion=(total follower count)/(ASFC_total). The Total Relative Follower Proportion may include any suitable range based on the total follower count and the total average sport follower count, such as, but not limited to, zero or a number greater than zero.

In a step 606, a following additive may be determined. The following additive may be based on all relative following proportions. The following additive may be equal to a sum of the total relative following proportions and a summation of platform specific relative following proportion. For example, following additive=(total relative following proportion)+(summation of platform specific relative following proportion).

In a step 608, an adjusted promotion count (APC) may be determined. The adjusted promotion count may be determined based on one or more of the base promotion count, the position multiplier, the experience multiplier, the award multiplier, the division multiplier, the status multiplier, and/or the following additive. For example, APC=(Base promotion count)*(team-sport multiplier)*(team multiplier)*(position multiplier)*(experience multiplier)*(award multiplier)*(division multiplier)*(status multiplier)+(following additive)

In a step 610, an effective promotion count (EPC) may be determined. The effective promotion count may be based on one or more of the adjusted promotion count and/or the maximum promotion count. If the adjusted promotion count is less than one, then the effective promotion Count may be equal to one. Alternatively, the effective promotion count may be equal to a lesser of the adjusted promotion count and the maximum promotion count.

In a step 612, the athlete earning potential may be determined. The athlete earning potential may be based on the total post value together with the effective promotion count. For example, athlete earning potential=(total post value)*EPC

The athlete earning potential may then be provided to the athlete for estimating an earning potential of the athlete, based on the number of sponsors posts the athlete can make during a year on each of the athlete's channels.

In embodiments, the server 102 may additionally handle various sponsorship transactions between the user and the sponsor. For example, the server 102 may include bank account or credit card information for the user and the sponsor. Upon deal completion, the sponsor may pay the user by the server 102. The server 102 may additionally handle disputes of deal completion and/or be configured to pause payment.

In embodiments, the sponsor may additionally add the user to a roster. By the roster, the sponsor may send the user free social media content.

In embodiments, the server 102 may include a chat functionality for facilitating a deal between the sponsor and the user.

In some embodiments, the one or more processors 104 of the platform server 102 may include a machine learning classifier. For example, the processors 104 may be configured to generate a machine learning classifier which may be used to calculate the suggested activity pricing using the valuation model. The machine learning classifier may include any type of machine learning algorithm/classifier and/or deep learning technique or classifier known in the art including, but not limited to, a random forest classifier, a support vector machine (SVM) classifier, an ensemble learning classifier, an artificial neural network (ANN), and the like. By way of another example, the machine learning classifier may include a deep convolutional neural network. For instance, in some embodiments, the machine learning classifier may include ALEXNET and/or GOOGLENET. In this regard, the machine learning classifier may include any algorithm, classifier, or predictive model configured to calculate a suggested activity pricing using the valuation model described herein.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system, the system comprising:
a user interface device including a display and a user input device, the user device configured to receive user input data from a user via the user input device, the user input data including at least activity type data, user identifier data, and user channel identifier data; and
a platform server including one or more processors configured to execute a set of program instructions stored in a memory, the platform server including a valuation model stored in the memory, the platform server communicatively coupled to the user interface device via a network, the set of program instructions configured to cause the one or more processors to:
receive real market data from a database, the real market data including completed deal data and disclosure data;
receive the user input data from the user device;
retrieve a real-time current follower count for the user using the received user channel identifier data;
filter, using the valuation model, the received real market data based on the received user input data;
determine, via the valuation model, at least one of an activity price per follower or an adjusted price per follower based on the retrieved real-time current follower count;
generate an adjusted dataset, using the valuation model, by adjusting the filtered received real market data based on the determined at least one the price per follower or the adjusted price per follower;
generate one or more match level tables, using the valuation model, by reducing the adjusted dataset based on one or more predetermined thresholds;
generate a final dataset based on the generated one or more match level tables using the valuation model; and
determine a suggested activity price for the user, using the valuation model, based on the generated final dataset.

2. The system of claim 1, wherein the user identifier data includes at least one of:
a student athlete identifier, a professional athlete identifier, a retired athlete identifier, an agent identifier, or a coach identifier.

3. The system of claim 1, wherein the activity type data includes at least one of:
a social media channel activity type, a digital media activity type, a graphical element activity type, or an in-person activity type.

4. The system of claim 1, wherein the user channel identifier data includes at least one of:
a social media channel handle or a social medial channel profile link.

5. The system of claim 1, wherein the filter, using the valuation model, the received real market data based on the received user input data comprises:
filtering, using the valuation model, the received real market data based on the identifier data and the activity type data.

6. The system of claim 5, wherein the identifier data includes a student athlete identifier and the activity type data includes a social media channel activity type.

7. The system of claim 1, wherein the one or more processors are configured to:
determine the activity price per follower based on the determined suggested activity price and the retrieved real-time current follower count.

8. The system of claim 7, wherein the one or more processors are configured to:
determine the adjusted price per follower based on the determined price per follower and a buyer type modifier.

9. The system of claim 8, wherein the buyer type modifier includes at least one of:
a donor modifier, a sponsor modifier, a brand modifier, a fan modifier, or a collective modifier.

10. The system of claim 1, wherein the one or more processors are further configured to:
generate one or more control signals configured to cause the display of the user device to display the determined suggested activity price.

11. The system of claim 1, wherein the user input data further includes sport data, the sport data including at least one of:
sport type data, institution data, league data, or division data.

12. The system of claim 1, wherein the database is stored in the memory of the platform server.

13. The system of claim 1, wherein the database is stored in a remote database, the remote database configured to communicatively couple to the platform server.

14. The system of claim 1, wherein the one or more predetermined thresholds include at least one of:
similar athlete, similar sport and institution, similar sport and conference, similar sport and league/division, similar institution, similar conference, or similar league/division.

15. The system of claim 1, wherein the generated match level table is sorted by match levels in ascending order.

16. The system of claim 1, wherein the generated match level table is sorted by activity date in descending order.

17. A method, the method comprising:
receiving real market data from a database, the real market data including completed deal data and disclosure data;
receiving user input data from a user via a user input device, the user input data including at least activity type data, user identifier data, and user channel identifier data;
retrieving a real-time current follower count for the user using the received user channel identifier data;
filtering the received real market data based on the received user input data;
determining at least one of an activity price per follower or an adjusted price per follower based on the retrieved real-time current follower count;
generating an adjusted dataset by adjusting the filtered received real market data based on the determined at least one the price per follower or the adjusted price per follower;
generating one or more match level tables by reducing the adjusted dataset based on one or more predetermined thresholds;
generating a final dataset based on the generated one or more match level tables; and
determining a suggested activity price for the user based on the generated final dataset.

18. The method of claim 17, further comprising:
generating one or more control signals configured to cause a display of the user device to display the determined suggested activity price to a user.

19. The method of claim 17, wherein the user identifier data includes at least one of:
a student athlete identifier, a professional athlete identifier, a retired athlete identifier, an agent identifier, or a coach identifier.

20. The method of claim 17, wherein the activity type data includes at least one of:
a social media channel activity type, a digital media activity type, a graphical element activity type, or an in-person activity type.

21. The method of claim 17, wherein the user channel identifier data includes at least one of:
a social media channel handle or a social medial channel profile link.

22. The method of claim 17, wherein the filter, using the trained valuation model, the received real market data based on the received user input data comprises:
filter the received real market data based on the identifier data and the activity type data.

23. The method of claim 22, wherein the identifier data includes a student athlete identifier and the activity type data includes a social media channel activity type.

24. The method of claim 17, further comprising:
determining the activity price per follower based on the determined suggested activity price and the retrieved real-time current follower count.

25. The method of claim 24, further comprising:
determine the adjusted price per follower based on the determined price per follower and a buyer type modifier.

26. The method of claim 25, wherein the buyer type modifier includes at least one of:
a donor modifier, a sponsor modifier, a brand modifier, a fan modifier, or a collective modifier.

27. The method of claim 17, wherein the user input data further includes sport data, the sport data including at least one of:
sport type data, institution data, league data, or division data.

28. The method of claim 17, wherein the one or more predetermined thresholds include at least one of:
similar athlete, similar sport and institution, similar sport and conference, similar sport and league/division, similar institution, similar conference, or similar league/division.

29. The method of claim 17, wherein the generated match level table is sorted by match levels in ascending order.

30. The method of claim 17, wherein the generated match level table is sorted by activity date in descending order.
